(19) United States
(12) Patent Application Publication
(10) Pub. No.: US 2021/0170998 A1
(43) Pub. Date: Jun. 10, 2021

(54) BRAKING SYSTEM WITH CONFIGURABLE FORCE FEEDBACK AND RELATED METHODS

(71) Applicant: Continental Automotive Systems, Inc., Auburn Hills, MI (US)

(72) Inventors: Paul Michael Robinson, Madison Heights, MI (US); Leah Burns, Grand Blanc, MI (US); Richard Blust, Grand Blanc, MI (US)

(73) Assignee: Continental Automotive Systems, Inc., Auburn Hills, MI (US)

(21) Appl. No.: 16/805,979

(22) Filed: Mar. 2, 2020

Related U.S. Application Data
(60) Provisional application No. 62/946,200, filed on Dec. 10, 2019.

(51) Int. Cl. B60T 7/04; G05G 5/03

(52) U.S. Cl. CPC B60T 7/042; G05G 5/03

(57) ABSTRACT

A braking system for a vehicle that has a default performance mode or first performance mode and an alternate performance mode or a second performance mode. The braking system includes a pedal assembly coupled with a master cylinder. The pedal assembly has a feedback force, and the pedal assembly has two or more activated positions and an inactivated position. A pedal feel simulator is coupled with the pedal assembly and the pedal feel simulator configured to apply force feedback to the pedal assembly. The pedal feel simulator is coupled with a simulator valve, and the simulator valve is configured to hold pressure within the pedal feel simulator when the braking system is in the second performance mode. A plurality of wheel brakes is hydraulically coupled with the master cylinder.

### TECHNICAL FIELD

The disclosure herein relates to a braking system.

### TECHNICAL BACKGROUND

Two-axle vehicles are fitted with hydraulic systems that have two brake circuits, thus ensuring that, if one of the two brake circuits fails, the vehicle can still be braked by means of the other brake circuit. In general, the wheel brakes are associated with the brake circuits in a diagonally split arrangement, in which a brake circuit acts on one front wheel and the respective diagonally opposite rear wheel. The two brake circuits are connected to a master brake cylinder, to which a brake pedal actuated by a driver to build up a corresponding brake pressure in the two brake circuits is coupled.

To implement a “brake-by-wire” brake system with a fallback level, a displacement simulator, an electrically controllable pressure source, two block valves (also referred to as connecting valves) and two circuit block valves are required in addition to the brake-pedal-actuated master brake cylinder. For the “brake-by-wire” operating mode, the wheel brakes are separated from the master brake cylinder by means of the block valves, while the wheel brakes are connected via the circuit block valves to a controllable pressure source common to both brake circuits or to a respective controllable pressure source provided for each of the brake circuits.

Such brake systems comprise a large number of hydraulic lines, which are interconnected by the valves in different ways, and therefore the occurrence of leaks cannot be excluded. Particularly in the case of “brake-by-wire” brake systems, there is the disadvantage that haptic feedback signals from the brake circuits are not transmitted to the brake pedal when said brake circuits are separated from the master brake cylinder. However, such haptic feedback is desired as a comfort feature. Therefore, a displacement simulator is connected in parallel with the master brake cylinder, said simulator imparting to the driver a pedal characteristic of a conventional brake system when the brake pedal is actuated if the wheel brakes are supplied with pressure medium from the pressure medium reservoir by the electrically controllable pressure source to generate a brake pressure. However, the disadvantage here is that it is not possible to achieve haptic feedback signals which indicate to the driver the safety and integrity of the brake system. This relates, for example, to increased volume inclusions, such as air or leaks, which are indicated in conventional brake systems by the absence of force feedback at the brake pedal. Mismatches in the volumes of a “brake-by-wire” brake system must therefore be detected electronically.

In addition, such brake systems comprise a large number of hydraulic lines, which are interconnected by the valves in different ways. The method in which the valves are connected prevent the feedback from road noise under braking from reaching the driver. By controlling the perceived driver force, the brake system can provide a more accurate feedback of road noise and situational events i.e ABS events.

What is needed is a way to provide adjustable force feedback for the driver.

### SUMMARY

A braking system including a first performance mode and a second performance mode, the braking system includes a pedal assembly coupled with a master cylinder, the pedal assembly having a feedback force, the pedal assembly having two or more activated positions and an inactivated position, a pedal feel simulator coupled with the pedal assembly, the pedal feel simulator configured to apply force feedback to the pedal assembly, the pedal feel simulator coupled with a simulator valve, the simulator valve configured to hold pressure within the pedal feel simulator when the braking system is in the second performance mode, a plurality of wheel brakes hydraulically or non hydraulically coupled with the master cylinder.

In one or more embodiments, the first performance mode is a default mode and the second performance mode is an alternate mode which provides a driver with a shorter travel and higher force pedal feel characteristic than in the default mode.

In one or more embodiments, the simulator valve is an analog valve.

In one or more embodiments, the braking system further includes a check valve coupled with the pedal feel simulator.

In one or more embodiments, the check valve is hydraulically connected in parallel with the analog valve.

In one or more embodiments, the braking system further includes a second simulator valve coupled with the pedal feel simulator.

In one or more embodiments, the second simulator valve is an analog valve.

In one or more embodiments, the second simulator valve is a digital valve.

In one or more embodiments, the feedback force is greater in the second performance mode than in the first performance mode.

In one or more embodiments, the pedal feel simulator is configured to apply force feedback to the pedal assembly via the master cylinder.

A method is disclosed herein and includes selecting a driving performance mode from at least one of a first performance mode and a second performance mode for a braking system, the braking system having a pedal assembly coupled with a master cylinder, the pedal assembly having a feedback force, the pedal assembly having two or more activated positions and an inactivated position, a pedal feel simulator coupled with the pedal assembly, the pedal feel simulator configured to apply force feedback to the pedal assembly, the pedal feel simulator coupled with a simulator valve, the simulator valve configured to hold pressure within the pedal feel simulator when the braking system is in the second performance mode, a plurality of wheel brakes hydraulically coupled with the master cylinder, selecting a pedal response force based on performance mode selection, where the pedal response force having a first pedal response force for the first performance mode and a second pedal response force for the second performance mode, and the first pedal response force is different than the second pedal response force, and configuring the pedal feel simulator to have the selected pedal response force.

In one or more embodiments, selecting the driving performance mode from at least one of the first performance mode and the second performance mode includes selecting from a comfort mode and a sport mode.

In one or more embodiments, the method further includes pre-filling fluid pressure within the pedal feel simulator.

In one or more embodiments, configuring the pedal feel simulator to have the selected pedal response force includes opening an analog valve connected with the pedal feel simulator.

In one or more embodiments, configuring the pedal feel simulator assembly to have the selected pedal response force includes opening at least one of a first valve and second valve connected with the pedal feel simulator.

### BRIEF DESCRIPTION OF THE DRAWINGS

FIG. 1 illustrates a schematic diagram of a braking system, as constructed in accordance with one or more embodiments.

FIG. 2 illustrates a schematic diagram of a braking system, as constructed in accordance with one or more embodiments.

These and other embodiments, aspects, advantages, and features of the present invention will be set forth in part in the description which follows and will become apparent to those skilled in the art by reference to the following description of the invention and referenced drawings or by practice of the invention. The aspects, advantages, and features of the invention are realized and attained by the instrumentalities, procedures, and combinations particularly pointed out in the appended claims and their equivalents.

### DETAILED DESCRIPTION

The following detailed description includes references to the accompanying drawings, which form a part of the detailed description. The drawings show, by way of illustration, specific embodiments in which the apparatus may be practiced. These embodiments, which are also referred to herein as “examples” or “options,” are described in enough detail to enable those skilled in the art to practice the present embodiments. The embodiments may be combined, other embodiments may be utilized, or structural or logical changes may be made without departing from the scope of the invention. The following detailed description is, therefore, not to be taken in a limiting sense and the scope of the invention is defined by the appended claims and their legal equivalents.

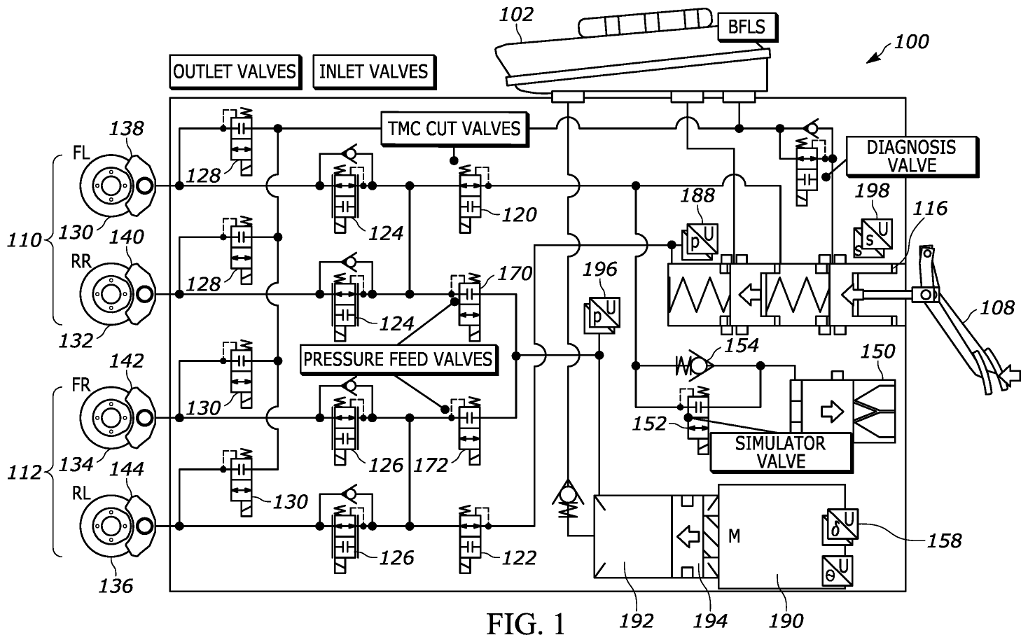

FIG. 1 shows an electronically controlled hydraulic or non-hydraulic braking system 100 for a vehicle having a first performance mode and a second performance mode, or a default performance mode and an alternate performance mode. In one or more embodiments, the first performance mode is a comfort mode and the second performance mode is a sport mode. In one or more embodiments, the braking system has a first brake circuit 110 and a second brake circuit 112. A brake control unit generates control signals for the valves of the two brake circuits 110 and 112 as output signals on the basis of sensor signals as input signals.

The first brake circuit 110 for a front left-hand wheel 130 (FL) and a rear right-hand wheel 132 (RR) is connected via a block valve 120 to a master brake cylinder 116. The second brake circuit 112 for a front right-hand wheel 134 (FR) and a rear left-hand wheel 136 (RL) is likewise connected to the master brake cylinder 116 via a block valve 122. Wheel brakes 138, 140 and 142, 144 of the wheels 130, 132 and 134, 136, respectively, are connected by respective hydraulic lines to the first brake circuit 110 and the second brake circuit 112.

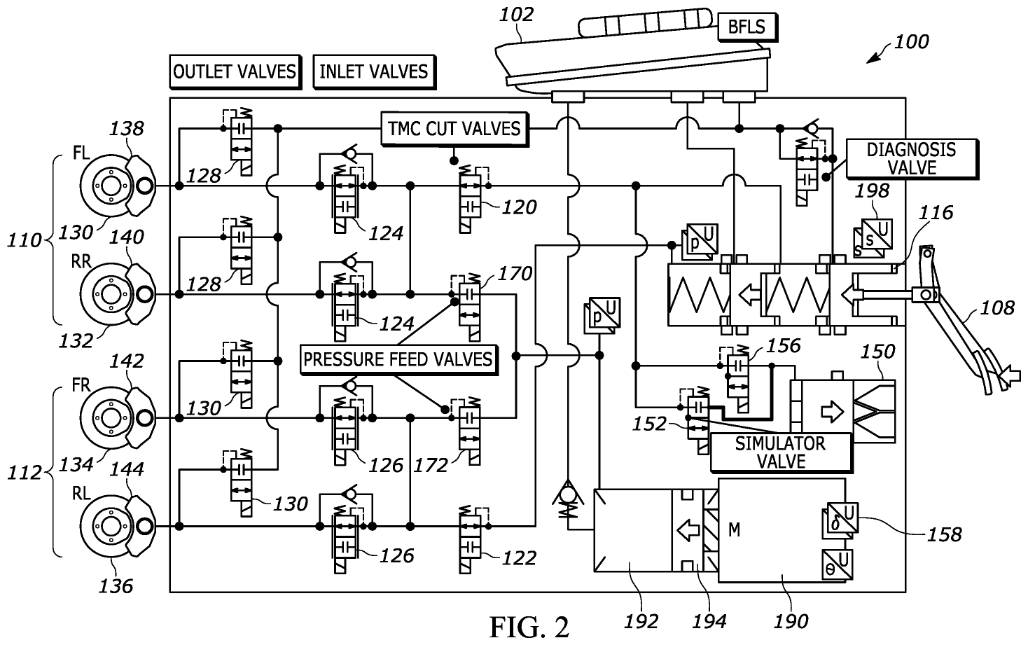

The braking system 100 includes a pedal assembly 108 coupled with a master brake cylinder 116. The pedal assembly 108 has a feedback force, and the pedal assembly 108 has two or more activated positions and an inactivated position. The master brake cylinder 116 can be actuated by a brake pedal assembly 108, a pedal feel simulator 150 interacting with the master brake cylinder 116, a pressure medium reservoir 102 connected to the master brake cylinder 116, an electrically controllable pressure source 192, which is designed as an electrohydraulic actuator with an electric motor 190 as a drive motor. The pedal feel simulator 150 is coupled with the pedal assembly 108, where the pedal feel simulator is configured to apply force feedback to the pedal assembly 108. The pedal feel simulator 150 is coupled with a simulator valve 152, where the simulator valve 152 is configured to trap pressure within the pedal feel simulator 150 when the braking system is in the second performance mode. In one or more embodiments, the simulator valve is an analog valve. In one or more embodiments, a check valve 154 is coupled with the pedal feel simulator 150. In one or more embodiments, the check valve 154 is hydraulically connected in parallel with the analog valve. In one or more embodiments, the braking system 100 further includes a second simulator valve 156, as shown in FIG. 2.

In one or more embodiments, the simulator valve 152 is modified to hold fluid pressure by increasing check valve spring force, for example by using an analog valve to increase pressure adjustability and reduce brake noise, vibration and harshness (NVH) during actuation. Initial activation of a second performance mode, such as sport mode, will allow the driver to actuate the pedal and fill the simulator. Upon pedal release, the simulator valve 152 will close and hold the desired prefill pressure in the simulator. Subsequent pedal applications while in this performance mode will now have a high pedal force feedback with respect to pedal travel, giving a sporty pedal feel.

The braking system further includes controllable pressure modulation devices with wheel brakes 138, 140 for a front left-hand wheel 130 (FL) and a rear right-hand wheel 136 (RL) and with wheel brakes 142, 144 for a front right-hand wheel 134 (FR) and a rear left-hand wheel 136 (RL), and a control unit.

An inlet valve and an outlet valve 124, 128 in each case form a pressure modulation device for the two wheel brakes 138, 140 of a first brake circuit 110, and an inlet valve and an outlet valve 126, 130 in each case form a pressure modulation device for the two wheel brakes 142, 144 of a second brake circuit 112.

In a “brake-by-wire” operating mode, the inlet valves 124 and 128 are connected via a circuit block valve 170 and 172, respectively, to the electrically controllable pressure source 192 for generating a system pressure. To measure the system pressure generated by the pressure source 192, a pressure sensor 196 is arranged on the high-pressure side thereof. Furthermore, each outlet valve 128,130 is connected to the pressure medium reservoir 102.

The master brake cylinder 116 is embodied as a dual-circuit tandem master cylinder and is connected to the pressure medium reservoir 102. To form a fall back plane of the “brake-by-wire” braking system 100, the master brake cylinder 116 can be connected to the wheel brakes 138, 140 of the first brake circuit 110 via a block valve 120 and to the wheel brakes 142, 144 of the second brake circuit 112 via another block valve 122. The brake pressure generated in this case is measured by a pressure sensor 188. Using the block valves 170 and 172, the hydraulic connection between the master brake cylinder 116 and the first and second brake circuit 110 and 112 is divided in the “brake-by-wire” operating mode.

A displacement sensor 198 is utilized to determine the extent of a pedal actuation brought about by the driver, i.e. the movement of a piston rod of the wheel brake cylinder 116, said piston rod being connected to the brake pedal assembly 108, is determined and represents a braking demand of the driver. The pedal feel simulator 150 is coupled hydraulically to the master brake cylinder 116 and simulates a haptic feedback corresponding to the brake pressure generated, i.e. a corresponding pedal feel, to the brake pedal assembly 108.

The electrically controllable pressure source 192 is designed, for example, as a single-circuit electrohydraulic actuator, the piston 194 of which can be actuated by an electric motor 190 via a rotation/translation mechanism. The piston 194 delimits a pressure space, which is connected to the pressure medium reservoir 102 in order to draw in pressure medium. The position of the piston 194 is determined from the rotor position of the electric motor 190, which is determined by a rotor position sensor 158, thus allowing the pressure medium volume delivered to be determined from said piston position.

A method is further provided herein. The method includes selecting a driving performance mode from at least one of a first performance mode and a second performance mode for a braking system, the braking system having a pedal assembly coupled with a master cylinder, the pedal assembly having a feedback force, the pedal assembly having two or more activated positions and an inactivated position, a pedal feel simulator coupled with the pedal assembly, the pedal feel simulator configured to apply force feedback to the pedal assembly, the pedal feel simulator coupled with a simulator valve, the simulator valve configured to trap pressure within the pedal feel simulator when the braking system is in the second performance mode, a plurality of wheel brakes hydraulically or non hydraulically coupled with the master cylinder, selecting a pedal response force based on performance mode selection, where the pedal response force having a first pedal response force for the first performance mode and a second pedal response force for the second performance mode, and the first pedal response force is different than the second pedal response force, and configuring the pedal feel simulator to have the selected pedal response force.

In one or more embodiments, selecting the driving performance mode from at least one of the first performance mode and the second performance mode includes selecting from a comfort mode and a sport mode. In one or more embodiments, the first performance mode is a default mode and the second performance mode is an alternate mode which provides a driver with a shorter travel and higher force pedal feel characteristic than in the default mode.

In one or more embodiments, the method further includes pre-filling fluid pressure within the pedal feel simulator.

In one or more embodiments, configuring the pedal feel simulator to have the selected pedal response force includes opening an analog valve connected with the pedal feel simulator.

In one or more embodiments, configuring the pedal feel simulator assembly to have the selected pedal response force includes opening at least one of a first valve and second valve connected with the pedal feel simulator.

The above description is intended to be illustrative, and not restrictive. Many other embodiments will be apparent to those of skill in the art upon reading and understanding the above description. Embodiments discussed in different portions of the description or referred to in different drawings can be combined to form additional embodiments of the present application. The scope should, therefore, be determined with reference to the appended claims, along with the full scope of equivalents to which such claims are entitled.

1. A braking system for a vehicle having a default performance mode and an alternate performance mode, the braking system comprising:
a pedal assembly coupled with a master cylinder, the pedal assembly having a feedback force, the pedal assembly having two or more activated positions and an inactivated position;
a pedal feel simulator coupled with the pedal assembly, the pedal feel simulator configured to apply force feedback to the pedal assembly, the pedal feel simulator coupled with a simulator valve, the simulator valve configured to hold pressure within the pedal feel simulator when the braking system is in the alternate performance mode; and
a plurality of wheel brakes are hydraulically or non hydraulically coupled with a pressure provider.

2. The braking system as recited in claim 1, wherein the first performance mode is a comfort mode and the second performance mode is a sport mode.

3. The braking system as recited in claim 1, wherein the simulator valve is an electromechanical valve.

4. The braking system as recited in claim 3, further comprising a check valve coupled with the pedal feel simulator.

5. The braking system as recited in claim 4, wherein the check valve is hydraulically connected in parallel with the electromechanical valve.

6. The braking system as recited in claim 1, further comprising a second simulator valve coupled with the pedal feel simulator.

7. The braking system as recited in claim 6, wherein the second simulator valve is an electromechanical valve.

8. The braking system as recited in claim 1, wherein the pressure provider is at least one of an electrical, electromechanical system or a mechanical system.

9. The braking system as recited in claim 1, wherein the pedal feel simulator is configured to apply force feedback to the pedal assembly via the master cylinder.

10. A method comprising:
selecting a driving performance mode from at least one of a first performance mode and a second performance mode for a braking system, the braking system having a pedal assembly coupled with a master cylinder, the pedal assembly having a feedback force, the pedal assembly having two or more activated positions and an inactivated position, a pedal feel simulator coupled with the pedal assembly, the pedal feel simulator configured to apply force feedback to the pedal assembly, the pedal feel simulator coupled with a simulator valve, the simulator valve configured to trap pressure within the pedal feel simulator when the braking system is in the second performance mode, a plurality of wheel brakes hydraulically coupled with the master cylinder;
selecting a pedal response force based on performance mode selection, where the pedal response force having a first pedal response force for the first performance mode and a second pedal response force for the second performance mode, and the first pedal response force is different than the second pedal response force; and
configuring the pedal feel simulator to have the selected pedal response force.

11. The method as recited in claim 10, wherein selecting the driving performance mode from at least one of the first performance mode and the second performance mode includes selecting from a comfort mode and a sport mode.

12. The method as recited in claim 10, further comprising pre-filling fluid pressure within the pedal feel simulator.

13. The method as recited in claim 10, wherein configuring the pedal feel simulator to have the selected pedal response force includes opening an analog valve connected with the pedal feel simulator.

14. The method as recited in claim 10, wherein configuring the pedal feel simulator assembly to have the selected pedal response force includes opening at least one of a first valve and second valve connected with the pedal feel simulator.
